(19) United States
(12) Patent Application Publication
(10) Pub. No.: US 2008/0257620 A1
(43) Pub. Date: Oct. 23, 2008

(54) Hybrid Vehicle Drive System

(76) Inventor: Peder Ulrik Poulsen, Stratford, CT (US)

Correspondence Address: ST. ONGE STEWARD JOHNSTON & REENS, LLC, 986 BEDFORD STREET, STAMFORD, CT, 06905-5619, US

(21) Appl. No.: 11/875,557

(22) Filed: Oct. 19, 2007

Related U.S. Application Data
(60) Provisional application No. 60/919,038, filed on Mar. 20, 2007.

(51) Int. Cl. B60K 6/22

(52) U.S. Cl. 180/65.2; 903/915

(57) ABSTRACT

A plug-in hybrid vehicle drive system, including an internal combustion engine for driving one or more wheels of an automobile, at least one on-wheel electrically powered motor for driving at least one wheel of the automobile, each on-wheel motor including a stator fixed outboard of the at least one wheel and a rotor mounted to an exterior face of the at least one wheel, a battery located in the automobile and connected to the at least one on-wheel motor for supplying power to the on-wheel motor, a battery charger including an AC/DC power converter, and an AC outlet connector in communication with the battery charger for receiving power from an external source.

### CROSS-REFERENCE TO RELATED APPLICATIONS

This application claims the benefit of, under 35 U.S.C. 119(e), U.S. Provisional Patent Application No. 60/919,038, filed Mar. 20, 2007, which application is hereby incorporated by reference herein.

### FIELD OF THE INVENTION

The present invention relates to hybrid drive automobiles generally and more particularly to plug-in hybrid automobiles.

### BACKGROUND OF THE INVENTION

Some hybrid drive automobiles, known as hybrid electric vehicles (“HEV”), incorporate an internal combustion engine as well as at least one electric motor and a bank of batteries. Contrary to all-electric vehicles, in these first generation hybrids the batteries are not charged from the utility grid but from a generator driven by the engine. The addition of the electric motor improves fuel economy by enabling the engine to run at its most economical speed at all times and to be shut down rather than idling when the car is stationary. In some hybrids both systems drive the wheels directly whereas in others, so called series hybrids, the engine drives only a generator, which powers the electric motor and/or charges the batteries. It is generally recognized that in a hybrid electric vehicle the rated electric power needs to be the same order of magnitude as the rated power of the combustion engine for best fuel economy.

Various hybrid vehicle drive systems are known and some have been implemented in production automobiles. For example, U.S. Pat. No. 6,864,652 to Kubo et al. (“the Kubo patent”) discloses a drive system for an automotive vehicle including an internal combustion engine for driving the front wheels and an ancillary electric motor for driving the rear wheels. The vehicle is operable in both a front-wheel drive mode and a four-wheel drive mode. However, prior art systems such as the one disclosed in the Kubo patent require substantial modification and/or remanufacture of the automobile power train to be implemented.

U.S. Pat. No. 6,644,427 to Schulte (“the Schulte patent”) discloses a system for providing parallel power in a hybrid vehicle. The system includes a compact electric motor that is coupled to an input shaft of the vehicle's transmission. The Schulte patent describes the system as being adaptable for installation in a conventional vehicle to convert it to a parallel hybrid-electric vehicle. However, the process requires the machining of components to fit the particular vehicle and requires modifications to the primary drive system of the vehicle including its drive shaft and transmission. For example, the conversion process described in the Schulte patent requires removing the vehicle's transmission and driveshaft, replacing the transmission input shaft, and mounting a motor to the transmission that is machined to fit the particular transmission.

There have been some prior attempts to employ in-wheel motors in automobiles. For example, U.S. Patent Application Publication No. 2007/0107959 to Suzuki et al. and U.S. Pat. No. 5,721,473 to DeVries disclose in-wheel motors. However, each of these prior art in-wheel motors include a cylindrical stator circumscribing the wheel. This design is disadvantageous because it substantially reduces the space available for brakes and suspension components, and requires an entirely new custom wheel. A similar in-wheel motor is also disclosed in U.S. Pat. No. 5,438,228 to Couture et al. Each of these prior art in-wheel motors reduce the space provided for the vehicle's brakes and suspension components, and are not also adaptable for use on a vehicle's existing wheel.

It is therefore desired to provide a hybrid vehicle drive system that overcomes the drawbacks of the prior art. It is further desired to provide a hybrid vehicle drive system readily adaptable for implementation in existing non-hybrid vehicles.

It is further desired to provide a hybrid vehicle drive system including plug-in capability. In recent years a novel category of hybrids, so called plug-in hybrids (“PHEV”) have appeared, designed to be charged from the electric grid while stationary. Plug-in hybrids further improve economy and mileage because energy drawn from the grid is many times less expensive than the same amount of energy delivered by an internal combustion engine. Several major automobile manufacturers are working towards commercializing plug-in hybrids however they are still several years away. Within the last two years, some PHEV has become available from aftermarket sources that generally comprise a conventional hybrid with added battery capacity and modified control systems and are able to operate in an all-electric mode for short durations. However, an improved hybrid vehicle system with plug-in capability is desired.

### SUMMARY OF THE INVENTION

The present invention is based on the fact that relatively little power is required to propel a light car at a steady rate in regular highway traffic. Many automobiles require only 10-15 horsepower or even less during maybe 80% of time on the road. In most cars the balance of available engine power is only required for acceleration and hill climbing.

Accordingly, it is a principal objective of the invention to provide an electric drive-assist system to be added to conventional cars. For example, a system according to the invention may comprise electric motors specially designed to bolt onto wheel flanges, preferably on the rear axles, replacing the original wheels but still utilizing the original suspension, brakes and wheel bearings. A drive system according to the invention also incorporates a bank of batteries and power management module located in the trunk or elsewhere in the vehicle.

It is a further objective of the invention to provide an electric in-wheel or on-wheel drive system, which is sufficiently simple to be retrofitted to an existing automobile by an auto repair shop or by a moderately mechanically proficient owner.

A further objective of the invention is to propose inexpensive factory modifications to automobiles originally designed with only a combustion engine (e.g., gasoline or diesel), in order to facilitate addition of a drive system according to the invention. The electric drive-assist system may be added by the factory during production, at purchase as a dealer option or at a later date whenever the owner may decide to do so.

These and other objectives are achieved by providing a plug-in hybrid vehicle drive system including an internal combustion engine for driving one or more wheels of an automobile, at least one on-wheel electrically powered motor for driving at least one wheel of the automobile, each on-wheel motor including a stator fixed outboard of the at least one wheel and a rotor mounted to an exterior face of the at least one wheel, a battery located in the automobile and connected to the at least one on-wheel motor for supplying power to the on-wheel motor, a battery charger including an AC/DC power converter, and an AC outlet connector in communication with the battery charger for receiving power from an external source while the batteries are being charged.

In some embodiments, the rotor includes a circular array of magnets mounted about the exterior face of the wheel driven by the on-wheel motor, and the stator is fixed outboard of both the wheel driven by the on-wheel motor and the circular array of magnets. In some embodiments, the system further includes at least one axle connectable to the automobile and extending through the at least one wheel driven by the on-wheel motor, and wherein the stator is fixedly mounted to a distal end of the axle. The system may also include a conduit mounted to an exterior portion of the automobile, and a power cable extending from the battery to the on-wheel motor via the conduit.

Other objects of the present invention are achieved by providing a plug-in hybrid vehicle drive system, including an internal combustion engine for driving two or more first wheels of an automobile, two or more permanent magnet motors for driving two or more second wheels of the automobile, wherein each of the permanent magnet motors is attached to the automobile outboard of one of the second wheels, a battery for supplying power to the two or more permanent magnet motors, an AC outlet connector for receiving AC power from an external source, and a power converter for converting the AC power and providing the converted power to the battery.

Other objects of the present invention are achieved by providing an on-wheel motor system for an automobile including a stator fixedly mounted to a distal end of an axle of an automobile, a wheel rotatable about the axle inboard of the stator, at least one circular array of magnets mounted about an exterior face of the wheel and axially adjacent to the stator, and a power cable connected to the stator for receiving electric power to the motor.

Further provided is a hybrid vehicle system including an internal combustion engine for driving two or more wheels of an automobile, at least one motor for driving at least one wheel of the automobile, the motor including a stator fixedly mounted to a distal end of an axle, wherein a wheel is rotatable about the axle, and at least one array of magnets mounted about an exterior face of the wheel and axially adjacent to the stator, at least one battery for supplying power to each of the at least one motor, a battery charger including an AC/DC power converter, and an AC outlet connector in communication with the battery charger for receiving power from an external source.

A typical candidate for addition of a drive-assist system according to the present invention is a light, small to mid-size automobile with an internal combustion engine driving either the front wheels or the rear wheels. The drive-assist system is installed on one or two axles and connected to a battery bank via a power management system located in the trunk or elsewhere in the car. The drive-assist system is largely independent of the original drive system, and control components enable the driver to operate the vehicle in engine mode or electric drive mode individually or together at will. Normally the car is started and brought up to cruising speed in engine mode, and then the gas pedal is released or the shift set to neutral, while engaging the drive-assist system. The on-wheel motors may then propel the car along a highway at a steady rate at zero or minimal fuel consumption. The engine can be re-engaged at any time and used together with or independently of the drive-assist system, but the system is designed to power the car on its own about 60-80% of the road time dependent on conditions and driver habits. It may also be able to perform low torque regenerative braking in either mode.

Other objects, features and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1A is a partial vertical section through a drive assembly according to the present invention.

FIG. 1B is a permanent magnet rotor and coreless stator used in the assembly shown in FIG. 1A.

FIG. 2A is a partial vertical section through another exemplary embodiment of a drive assembly according to the invention.

FIG. 2B is a permanent magnet rotor and coreless stator used in the assembly shown in FIG. 2A.

FIG. 3 is an example for comparison of a conventional axle and axle nut.

FIG. 4 is a schematic representation of the components of an electric drive-assist system according to an exemplary embodiment of the present invention.

FIG. 5 is a partial section through a drive-assist system according to another exemplary embodiment of the present invention fitted to a non-driven axle which has not been modified to receive the system.

FIG. 6 is the rear portion of an automobile outfitted with the drive-assist system shown in FIG. 5.

FIG. 7A is a partial section through a drive assist system according to another exemplary embodiment of the present invention.

FIG. 7B is a rear portion of an automobile viewed from the side, equipped with the drive system shown in FIG. 7A.

FIG. 7C is a rear view of the automobile shown in FIG. 7B.

FIG. 8A is another partial section view of the drive assist system shown in FIG. 7A including an additional stator and additional arrays of permanent magnets.

FIG. 8B is a side view of the drive assist system shown in FIG. 8A.

FIG. 9 is a partial section view of a drive assist system according to another exemplary embodiment of the present invention, shown externally attached onto an original wheel.

### DETAILED DESCRIPTION OF THE INVENTION

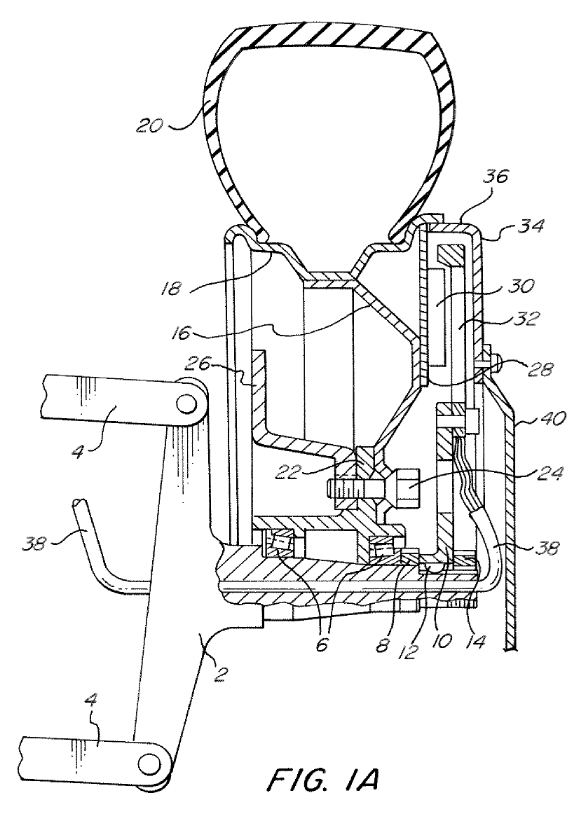

FIG. 1A illustrates a drive-assist assembly according to the invention. The assembly includes a normally non-driven axle 2 of an automobile supported by suspension arms 4. Suspension components such as springs and shock absorbers as well as brake calipers are not shown in the drawing for the sake of clarity.

As will be apparent to one of ordinary skill in the art, one of the substantial differences between the drive-assist assembly of FIG. 1A and prior art in-wheel motors is the arrangement of the motor outboard of the wheel. As such, the drive-assembly according to present invention may be referred to as an on-wheel motor.

The axle 2 is of largely conventional construction comprising two tapered roller bearings 6 but it has been modified by adding a central bore and a keyed and threaded shaft extension portion beyond the original retaining nut 8. The shaft extension serves to receive the hub of a flange 10, which is prevented from rotating by a key 12 and secured axially by a second nut 14. The wheel, in this case a pressed sheet metal construction, comprises a hub 16 and rim 18 holding a tire 20. The wheel is mounted onto a flange 22 with bolts 24 also securing brake disc 26. Regularly spaced holes in flange 10 provide access to the four or five wheel bolts 24.

In the present embodiment, a ring of sheet steel 28 is attached to the outward facing rim 18 and welded to the hub 16 near its inner edge. Sector shaped rare earth high-energy permanent magnets 30 are bonded to the ring surface 28 and arranged in a circular pattern with their north and south poles oriented alternately outwards and inwards facing ring 28.

Shown in FIG. 1B, a stator 32 consisting of sector wound coils assembled as “flower petals” and embedded in high mechanical integrity plastic or resin is bolted to flange 10, with its inward facing surface in close proximity to the array of permanent magnets 30. A second ring of heavy sheet steel 34 with an inward protruding rim 36 is placed in close proximity to the opposite surface of the stator and serves to close the magnetic fields exerted by magnets while at the same time enclosing the stator windings and permanent magnet rotor. The individual coils are arranged in groups of three, interconnected and terminated into a three-conductor cable 38.

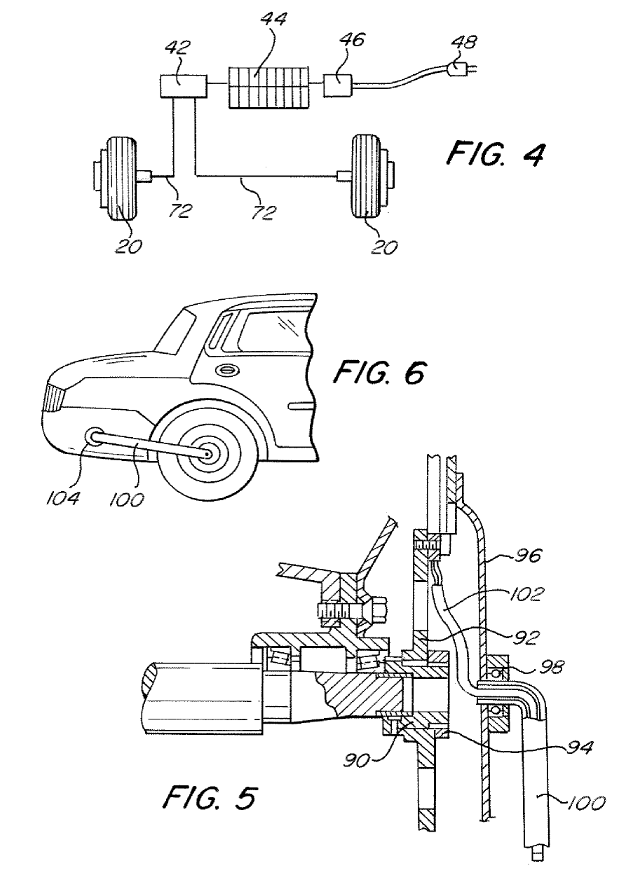

The cable 38 is guided through the central bore in the axle and on to a power management module 42, located in the trunk or elsewhere in the automobile together with the battery module 44, charger 46 (e.g., including a DC to AC power converter), and AC outlet connector 48 (see, e.g., FIG. 4). The battery module 44 may include, for example, a plurality of lead acid batteries or preferably lithium-ion batteries. The wheel assembly is protected from the environment by a hubcap 40.

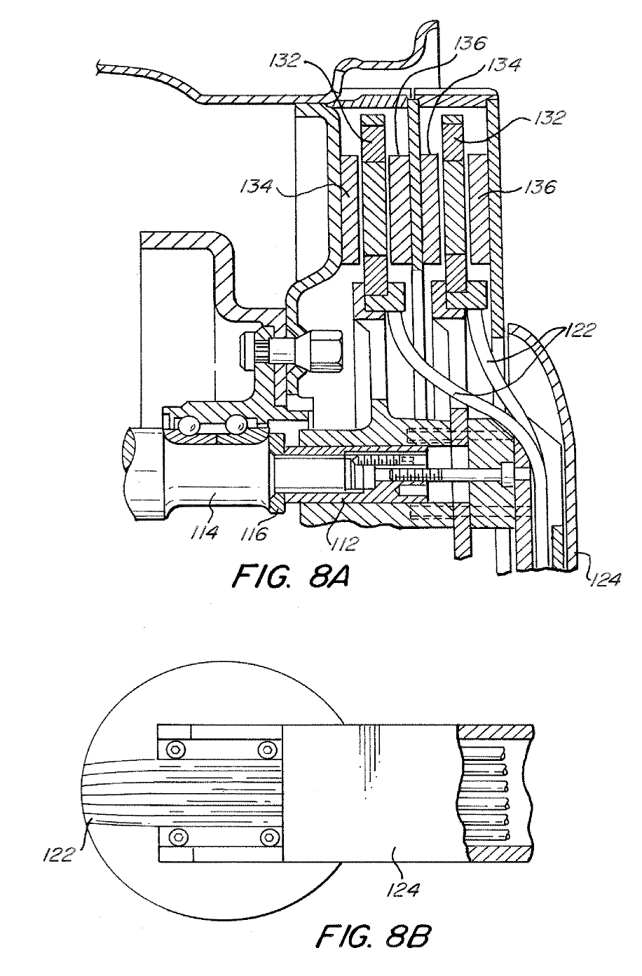

The stator winding 32 and the steel ring 28 comprise an Axial Field Permanent Magnet (AFPM) disc-type, brush-less motor, a category of motor well suited for the on-wheel power assist drive according to the invention. In the exemplary embodiment, the motor has a diameter equal to or less than that of the vehicle wheel and a thickness of about 2 inches extending outboard of the wheel. The added weight of the system is also minimal and may include, for example, approximately 30 lbs. or less per wheel. One exemplary system according to the present invention provides approximately 5 kW or 6.5 horsepower per wheel at 1000 rpm. However, other embodiments may provide substantially more power if desired for particular applications. For example also suitable according to the invention are AFPM motors with two or more core-less or iron core stators or two or more permanent magnet rotors arranged coaxially for increased torque, as well as any other electric motor, which will fit into the wheel assembly (See, e.g., FIGS. 8A-8B)

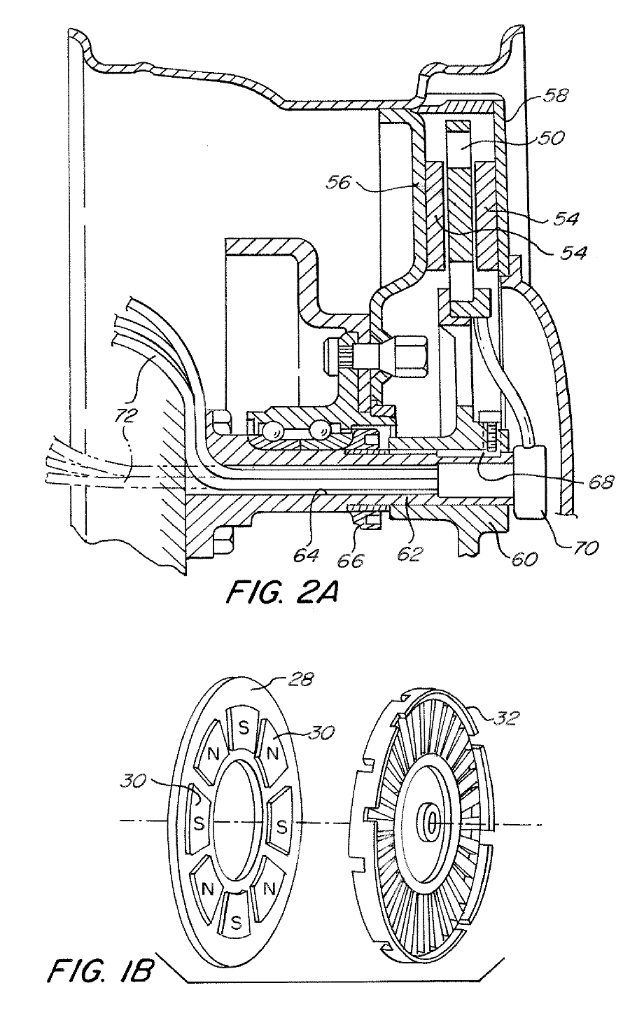

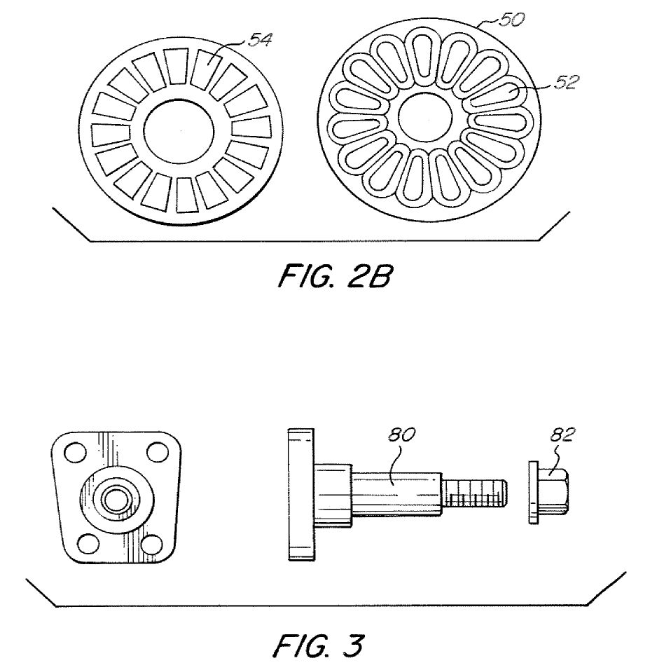

FIGS. 2A-2B illustrate another preferred embodiment of a drive system according to the invention of the same general principle as the one shown in FIG. 1A. The stator 50 of the AFPM motor comprises triangular coils 52 arranged in a circular, non-overlapping pattern and embedded in resin to form a stator disk 50. Permanent magnets 54 form two circular patterns with alternating North and South poles, the first pattern mounted directly onto the steel hub disk 56 and the second pattern mounted onto the external circular steel ring 58. The stator disk 50 is fitted onto a flange 60 with a central bore, which fits onto a cylindrical extension of the axle pinion 62. For comparison, FIG. 3 illustrates a typical conventional axle 80 and nut 82. The modified axle 62 according to the invention comprises a concentric bore 64, an extension protruding outward beyond the ring nut 66 and a slot for a key 68 matching a keyway in the central part of flange 60. The shaft extension also contains a receptacle for a plug connector 70 serving to connect the stator coils with wires 72 extending through the axle bore 64 and on to the power management module 42 located elsewhere in the vehicle.

FIG. 5 illustrates another drive-assist system according to the invention fitted to a non-driven axle without the shaft extension and central bore described in the above. The present embodiment includes a central retaining nut 90 that is elongated and keyed and threaded to receive flange 92 and its retaining nut 94. A hubcap 96 is provided with a central ball bearing 98, which supports a conduit 100 containing the power cable 102. As shown in FIG. 6, the conduit 100 of the present embodiment extends rearwards and connects into the trunk space of the vehicle through a rubber lined bushing 31 attached to the body behind the wheel. In some other embodiments, the conduit 100 extends underneath the vehicle and into the truck space to avoid piercing of the vehicle's body.

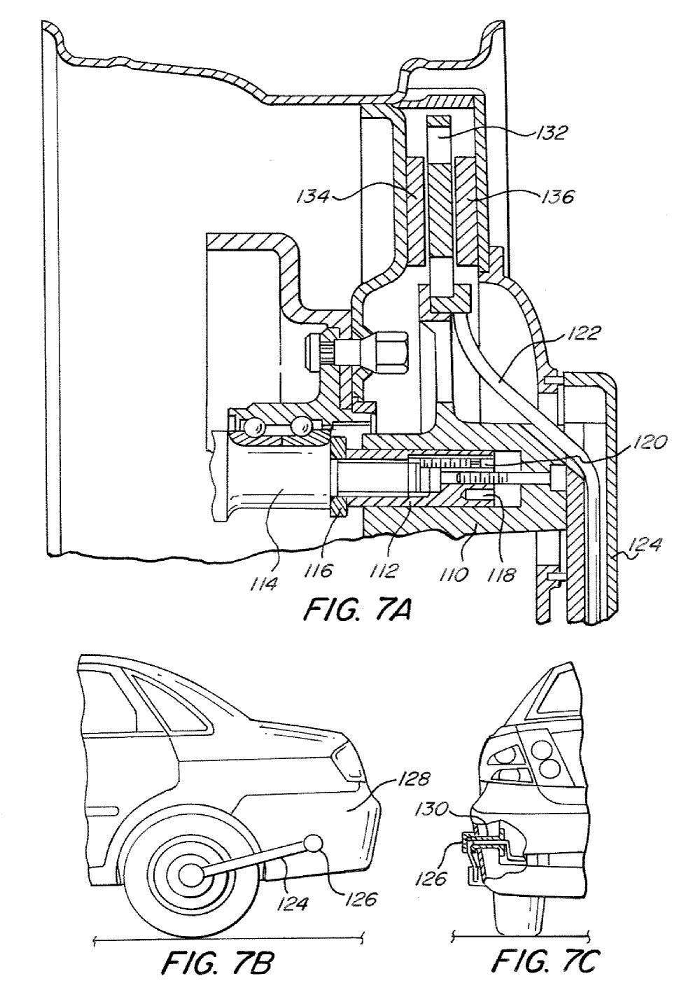

FIG. 7A illustrates another preferred embodiment of the drive assist system according to the present invention comprising the wheel construction, permanent magnets and stator described above but designed to be mounted onto the original, un-modified axle. In the present embodiment, a cylindrical bore of the stator flange 110 fits over an extended axle nut 112, which is screwed on to the original thread of the axle 114 and holds the bearing assembly in place by means of a washer 116.

The tubular nut 112 is tightened by means of a special key (not shown) having pins engaging two or three bores 118 in the end of the nut 112, and it secured after tightening by a set screw 120, which is tightened against the axle end. The stator wires 122 extend through a hollow conduit 124 (e.g., rectangular conduit), which is bolted or otherwise secured to the front end of flange 110. In some embodiments, the conduit 124 is substantially rigid for absorbing torque from the stator. The conduit 124 extends from the center of the motor rearwards to an attachment assembly 126, which connects with the quarter panel through a bore in the rear fender skin or bumper. As shown in FIGS. 7B-7C, the assembly 126 is attached to the quarter panel 128 of the vehicle, and a channel 130 through the assembly provides access for the stator wires 122 in the trunk space.

FIGS. 8A-8B illustrate a variation of the drive system shown in FIG. 7A. As described above, embodiments of the present invention may include two or more stators and/or two or more permanent magnet rotors arranged coaxially for increased torque. The illustrated embodiment therefore includes an additional stator 132 and additional arrays of magnets 134/136. In other embodiments, the system includes three or four stators and rotors for larger power ratings.

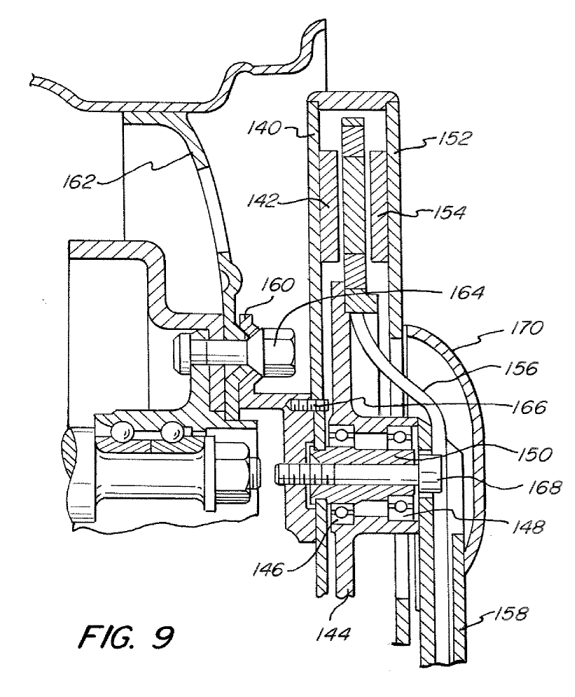

FIG. 9 is a different embodiment of a drive system according to the invention, featuring an external AFPM motor, which is bolted externally onto the original wheel of a conventional automobile. An internal array of permanent magnets 142 is mounted onto a circular steel plate 140 and the stator flange 144 is mounted on ball bearings 146 and 148, seated on a hollow shaft 150, which is attached to and protrudes outward from plate 140. An external array of permanent magnets 154 are mounted onto a circular plate 152, and the stator wires 156 extend through a hollow conduit 158 connecting with the rear body of the vehicle, e.g., in the manner described above. A connecting flange 160 with the same bolt pattern as the original wheel is placed onto the hub 162 and held in place by the wheel nuts 164. Part of the connecting flange 160 is a cylindrical mount, with a central thread and a number of pins 166, which match corresponding holes in plate 140. The wheel motor is mounted by means of a central bolt 168 and the opening and wire entry point are covered by a hubcap 170.

As one of ordinary skill will understand from the preceding description, the present invention provides a novel system for supplementing power to an automobile as an aftermarket or dealer installed add-on system, or as an original equipment option on the automobile. The present invention may be implemented with minimal modification to the automobile and minimal added weight. For example, some embodiments of the present invention employ the existing axles and wheels of the automobile. By way of the present invention, any automobile may be readily converted into a hybrid vehicle and preferably a plug-in hybrid vehicle.

Although the invention has been described with reference to a particular arrangement of parts, features and the like, these are not intended to exhaust all possible arrangements or features, and indeed many modifications and variations will be ascertainable to those of skill in the art.

What is claimed is:

1. A plug-in hybrid vehicle drive system, comprising:
an internal combustion engine for driving one or more wheels of an automobile;
at least one on-wheel electrically powered motor for driving at least one wheel of the automobile, each on-wheel motor including a stator fixed outboard of the at least one wheel and a rotor mounted to an exterior face of the at least one wheel;
a battery located in the automobile and connected to said at least one on-wheel motor for supplying power to said on-wheel motor;
a battery charger including an AC/DC power converter; and
an AC outlet connector in communication with said battery charger for receiving power from an external source.

2. The system according to claim 1,
wherein the rotor includes a circular array of magnets mounted about the exterior face of the wheel driven by said on-wheel motor; and
wherein the stator is fixed outboard of both the wheel driven by said on-wheel motor and the circular array of magnets.

3. The system according to claim 2, furthering comprising:
a wheel cover fixedly attached to the wheel driven by said on-wheel motor, at least a portion of said wheel cover being outboard of the stator; and
a second rotor including a second circular array of magnets mounted about an interior face of said wheel cover.

4. The system according to claim 1, further comprising:
at least one axle connectable to the automobile and extending through the at least one wheel driven by said on-wheel motor; and
wherein the stator is fixedly mounted to a distal end of the axle.

5. The system according to claim 4,
wherein the distal end of the axle includes a first retaining nut for retaining the at least one wheel driven by said on-wheel motor; and
wherein the distal end of the axle further includes a threaded axle extension for receiving said stator and a stator retainer.

6. The system according to claim 4, wherein said axle is an original equipment axle of the automobile.

7. The system according to claim 1,
wherein each on-wheel motor includes at least one additional stator and at least one additional rotor axially adjacent to the at least one additional stator.

8. The system according to claim 1, wherein said stator includes at least one of a plurality of wound coils and an iron core.

9. The system according to claim 1, further comprising:
a substantially circular plate fixedly mounted to an outboard face of the wheel driving by the on-wheel motor, said plate including the rotor;
a shaft extending outboard from a center portion of said plate; and
wherein said stator is rotatably attached to said shaft.

10. The system according to claim 1, further comprising:
a conduit mounted to an exterior portion of the automobile; and
a power cable extending from said battery module to the on-wheel motor via said conduit.

11. The system according to claim 10, further comprising:
a wheel cover fixedly attached to the wheel driven by said on-wheel motor, said wheel cover including a rotatable coupling,
wherein a distal end of said conduit is connected to the rotatable coupling.

12. The system according to claim 10,
wherein said conduit is a substantially rigid conduit;
wherein the stator is fixedly attached to a distal end of said conduit; and
wherein said conduit substantially prevents rotation of the stator.

13. The system according to claim 1, further comprising:
at least one axle comprising a center bore;
at least one power cable extending from said battery module to the stator via the center bore; and
wherein the stator is mounted to a distal end of said axle.

14. The system according to claim 13,
wherein the distal end of the axle includes a key to prevent the stator from rotating.

15. The system according to claim 1, further comprising:
a driver operable controller in communication with said battery for controlling the power supplied to the at least one on-wheel motors.

16. The system according to claim 1, wherein at least one wheel of the automobile is drivable by both said internal combustion engine and said on-wheel motor.

17. The system according to claim 1, wherein said internal combustion engine is fueled by a diesel fuel.

18. A plug-in hybrid vehicle drive system, comprising:
an internal combustion engine for driving two or more first wheels of an automobile;
two or more permanent magnet motors for driving two or more second wheels of the automobile, wherein each of said permanent magnet motors is attached to the automobile outboard of one of the second wheels;
a battery for supplying power to said two or more permanent magnet motors;
an AC outlet connector for receiving AC power from an external source; and
a power converter for converting the AC power and providing the converted power to the battery.

19. The system according to claim 18,
wherein each of said permanent magnet motors includes a stator fixed outboard of the second wheel and a rotatable array of magnets axially adjacent to the stator.

20. The system according to claim 19,
wherein the rotatable array of magnets is positioned inboard of the stator;
wherein the system further comprises a wheel cover fixedly attached to the second wheel, at least a portion of the wheel cover being outboard of the stator; and
wherein the wheel cover includes a second array of magnets mounted about an interior face of said wheel cover and axially adjacent to the stator.

21. An on-wheel motor system for an automobile, comprising:
a stator fixedly mounted to a distal end of an axle of an automobile;
a wheel rotatable about the axle inboard of said stator;
at least one circular array of magnets mounted about an exterior face of the wheel and axially adjacent to said stator; and
a power cable connected to said stator for receiving electric power to the motor.

22. The system according to claim 21, further comprising:
a wheel cover fixedly attached to the wheel, at least a portion of said wheel cover being outboard of the stator; and
a second array of magnets mounted about an interior face of said wheel cover and axially adjacent to said stator.

23. The system according to claim 21, wherein the axle includes a center bore, and wherein said power cable extends via the center bore to said stator.

24. A hybrid vehicle system, comprising:
an internal combustion engine for driving two or more wheels of an automobile;
at least one motor for driving at least one wheel of the automobile, said motor comprising a stator fixedly mounted to a distal end of an axle, wherein a wheel is rotatable about the axle, and at least one array of magnets mounted about an exterior face of the wheel and axially adjacent to said stator;
at least one battery for supplying power to each of the at least one motor;
a battery charger including an AC/DC power converter; and
an AC outlet connector in communication with said battery charger for receiving power from an external source.

25. The system according to claim 24, wherein the axle is an original equipment axle of the automobile.
